(19) United States
(12) Patent Application Publication
(10) Pub. No.: US 2011/0222541 A1
(43) Pub. Date: Sep. 15, 2011

(54) Network System, Edge Node, and Relay Node

(75) Inventors: Takumi OISHI, Yokohama (JP); Norihisa Matsumoto, Yokohama (JP); Kiyotaka Takahashi, Tsurugashima (JP); Hideki Endo, Yokohama (JP)

(73) Assignee: Hitachi, Ltd., Tokyo (JP)

(21) Appl. No.: 12/979,784

(22) Filed: Dec. 28, 2010

(30) Foreign Application Priority Data
Mar. 15, 2010 (JP) 2010-057012

(51) Int. Cl. H04L 12/56

(52) U.S. Cl. 370/392

(57) ABSTRACT

Edge nodes form point-to-point communication paths with one another. Multiple communication paths set at one port of an edge node and/or a relay node are regarded as a group. Identification information of the port and identification information of a group that outputs a frame inputted into the port are previously stored as associated with each other. If the destination address of a frame inputted into the port is unknown, an outgoing interface search unit identifies at least one group corresponding to the port. The frame is outputted from a port corresponding to the identified group.

### CLAIM OF PRIORITY

The present application claims priority from Japanese patent application JP 2010-057012 filed on Mar. 15, 2010, the content of which is hereby incorporated by reference into this application.

### FIELD OF THE INVENTION

The present invention relates to a network system, an edge node, and a relay node and, in particular, to a network system, an edge node, and a relay node that suppress flooding when receiving a frame with an unknown MAC address (this frame means a frame with a destination MAC address that does not exist in the MAC address learning table).

### BACKGROUND OF THE INVENTION

Ethernet®, which has been used in small-scale networks, has also been used in large-scale networks operated by communications carriers in recent years. For example, as disclosed in JP-A-2007-266850, Ethernet-compliant communication devices include a function unit called “flooding.” Ethernet-compliant communication devices also include a function unit that stores the MAC address of a terminal connected to a communication port thereof. This is done by extracting a source MAC address in a frame passing through the port. When an Ethernet-compliant communication device receives a frame containing a destination MAC address, it transmits the frame from a port thereof corresponding to the destination MAC address if it has already known the MAC address. If the Ethernet-compliant communication device has not known the destination MAC address, it does not know from which communication port it should transmit the frame. Accordingly, it transmits the frame from all ports other than the port via which it has received the frame. This is called “flooding.” Multiple copies of one data frame are made by flooding. The copied frames use the communication bandwidth excessively. For this reason, means for preventing this in an Ethernet switch device is disclosed in JP-A-2007-266850.

On the other hand, communications carriers are using communication devices conforming to the MPLS (multi protocol label switching) standard disclosed in pp. 9 to 37 of RFC3031, Multiprotocol Label Switching Architecture, E. Rosen et al., http://www.ietf.org/rfc/rfc3031.txt. The MPLS standard was first standardized as a system using point-to-point communication paths, which each connect two points in a large-scale network. Moreover, in order for communications carriers to provide private line services, it is sufficient to establish point-to-point connections. Communication devices that can only establish point-to-point connections are already available and being operated by communications carriers.

Meanwhile, in recent years, attention has been paid to wide-area LAN connection services, which connect three or more points. JP-A-2005-354424 discloses a method for providing the above-mentioned LAN connection services in a network system including MPLS-compliant devices. JA-A-2005-354424 discloses that LAN connections are established by setting, for example, MPLS-based point-to-point communication paths in full mesh between all edge nodes located at edges of a network system. This makes it possible to provide wide-area LAN connection services using existing communication devices that can only establish point-to-point connections.

In this network system, each node receives an Ethernet frame from an external network, converts the Ethernet frame into an MPLS frame, selects a path on the basis of the destination of the frame, and transmits the MPLS frame onto the selected path. In selecting a path on the basis of the destination, each edge node faces the same event and problem as flooding disclosed in JA-A-2007-266850.

### SUMMARY OF THE INVENTION

In a network system including point-to-point communication paths, edge nodes located at edges of the network system have the following problems.

When an edge node receives an Ethernet frame containing an unknown destination MAC address, it transmits the Ethernet frame via all paths other than the path via which it has received the Ethernet frame (flooding). In the case where multiple paths having different destination edge nodes are multiplexed on the single physical communication path between an edge node and an adjacent relay node, a number of frames corresponding to the number of the multiplexed paths are transmitted (flooded). The challenge is to reduce the number of frames to be flooded so as to increase the bandwidth use efficiency of the physical communication path.

Accordingly, an object of the present invention is to reduce the number of frames to be flooded on the single physical communication path in transferring a frame containing an unknown MAC address into a network system including point-to-point communication paths.

In this invention, an edge node provides a first means for determining the range of paths onto which frames are to be flooded. An edge node also provides a second means for determining the range of paths belonging to a single physical port. Hereafter, the range of labels for identifying the paths determined by the first means is referred to as a “label set,” and the range of the paths determined by the first and second means is referred to as a “path group.” An edge node also provides a third means for managing the label set and a fourth means for managing the path group. An edge node includes a fifth means for, when receiving an Ethernet frame containing an unknown destination MAC address, determining the path group as the transfer destination of the frame. A relay node includes a sixth means for, when receiving a frame at the combination of the label set and a physical port, determining the transfer destination of the frame.

The network system that is composed of the edge nodes and the relay nodes is, for example, a network system including point-to-point communication paths. In the case where three or more points are connected to establish a LAN connection, communication devices forming the network system each includes means for regarding, as one set, multiple communication paths belonging to a single LAN connection and managing the single LAN and means for regarding, as one group, multiple communication paths belonging to one port in the one set and managing the one group. This network system is an information transfer system having a characteristic that the transfer destinations of multiple data frames obtained by copying one data frame is determined on a group-by-group basis.

In order to manage the groups, communication devices for realizing the above-mentioned communication system each includes, for example, means for identifying a LAN connection to which a frame to be communicated belongs by the identifier of a device component, such as the number of an interface card or port into which the frame has been inputted and information in the frame, such as VLAN ID and MAC address, and managing the identified LAN connection, means for managing, as one set, multiple communication paths belonging to the LAN connection, means for classifying the multiple communication paths included in the one set by group and managing the classified communication paths, and means for selecting one communication path from a corresponding group and transmitting the frame via the selected communication path.

In order to manage the groups, the communication devices for realizing the above-mentioned communication system also each include, for example, means for identifying a port-specific communication path belonging to a LAN connection to which a frame to be communicated belongs by the identifier of a device component, such as the number of an interface card or port into which the frame has been inputted and information in the frame, such as the identifier of a communication path, and managing the identified port-specific communication path and means for, in a case where there are multiple such port-specific communication paths, copying the data frame by the number of the communication paths minus one and transmitting one frame to each of the communication paths.

According to an aspect of the present invention, a network system includes: a plurality of edge devices that form point-to-point communication paths with one another and transmit or receive frames to or from one another via the point-to-point communication paths; and a relay device that relays frames between the edge devices. The edge devices and/or the relay device each include: a plurality of ports that receive and output frames; a memory where communication paths set at one of the ports are regarded as a group and where identification information of the port and identification information of a group that outputs a frame inputted into the port are previously stored as associated with each other; and an outgoing interface search unit that, if the destination address of a frame inputted into the port is unknown, searches the memory to identify at least one group corresponding to the port. The frame containing the unknown destination address is outputted from a port corresponding to the identified group. Other aspects of the present invention provide the above-mentioned edge devices and relay device.

According to the present invention, it is possible to reduce the number of frames to be flooded onto the single physical communication path in transferring a frame containing an unknown MAC address into a network system including point-to-point communication paths.

### BRIEF DESCRIPTION OF THE DRAWINGS

FIG. 1 is a diagram showing the configuration of a network system according to the present invention;

FIG. 2 is a diagram showing the configuration of an edge node;

FIG. 3 is a diagram showing the configuration of an Ethernet interface card of the edge node;

FIG. 4 is a diagram showing the configuration of an MPLS interface card of the edge node;

FIG. 5 is a diagram showing the configuration of a relay node;

FIG. 6 is a diagram showing the configuration of an MPLS interface card of the relay node;

FIGS. 7A, 7B, and 7C are diagrams showing a frame format;

FIG. 8 is a diagram showing a table of MAC address learning and routing in the edge node;

FIG. 9 is a diagram showing an example of a table of “Label Set” in the edge node;

FIG. 10 is a diagram showing a table of “Path Group” in the edge node, where each label set and path groups are associated with each other;

FIG. 11 is a diagram showing an example of a table of MAC address learning in the edge node;

FIGS. 12A, 12B, and 12C are diagrams showing an example of a table of “Label Set” in the relay node;

FIG. 13 is a diagram showing the preparation flow of the table of MAC address learning and routing of the edge node;

FIG. 14 is a diagram showing the preparation flow of the table of MAC address learning of the edge node;

FIG. 15A is a diagram showing the process that the edge node performs when receiving a frame from an external network and FIG. 15B is a diagram showing the process that the edge node performs in transmitting a frame to the external network;

FIG. 16A is a diagram showing the process that the edge node performs when receiving a frame from a P2P network and FIG. 16B is a diagram showing the process that the edge node performs in transmitting a frame to the P2P network; and

FIG. 17A is a diagram showing the process that the relay node performs when receiving a frame and FIG. 17B is a diagram showing the process that the relay node performs in transmitting a frame.

### DESCRIPTION OF THE PREFERRED EMBODIMENTS

Now, an embodiment of the present invention will be described in detail with reference to the accompanying drawings.

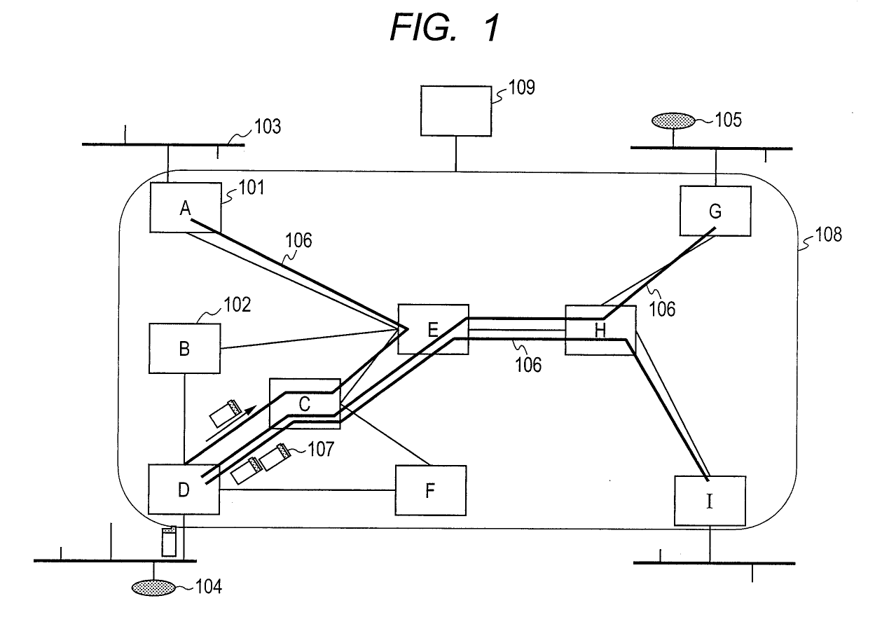

FIG. 1 shows an example configuration of a network system for reducing frames to be flooded according to this embodiment.

Nodes 101 (A, D, G, and I) are edge nodes, and nodes 102 (B, C, E, F, and H) are relay nodes. For example, these nine nodes form a P2P network system 108, which is managed by a manager server 109. Four external networks 103 are connected to the P2P network system 108.

To connect among the four external networks, full-mesh point-to-point communication paths are set in the P2P network system 108. In FIG. 1, three full-mesh paths are seen from the edge node D (106).

The edge nodes 101 transmit or receive frames to or from one another via the point-to-point communication paths. The relay nodes 102 relay frames between the edge nodes 101.

Here, assume that, according to the related art rather than this embodiment, a transmission terminal 104 of the external network connected to the edge node D transmits data to a reception terminal 105 of the external network connected to the edge node G. If the edge node D has not known the MAC address of the reception terminal 105, the transmission terminal 104 transmits the data frame as follows. Since the edge node D has not known the MAC address of the reception terminal 105, which is the destination of the data frame, it does not know onto which path it should transmit the frame and therefore floods it onto all the full-mesh paths. Since three paths are present toward the relay node C, the edge node D transmits three frames having the same contents onto the physical link between the edge node D and the relay node C.

However, the edge node D does not need to transmit as many as three frames having the same contents onto the physical link. Use of this embodiment can prevent transmission of multiple frames having the same contents onto the physical connect between the edge node D and the relay node C, using the bandwidth effectively. In this embodiment, first, the configuration of the edge nodes and the relay nodes and the configuration of tables used in the frame transfer process and the method for preparing the tables will be described. Then, the flows of frame processing and flooding that the edge nodes and the relay node perform will be described.

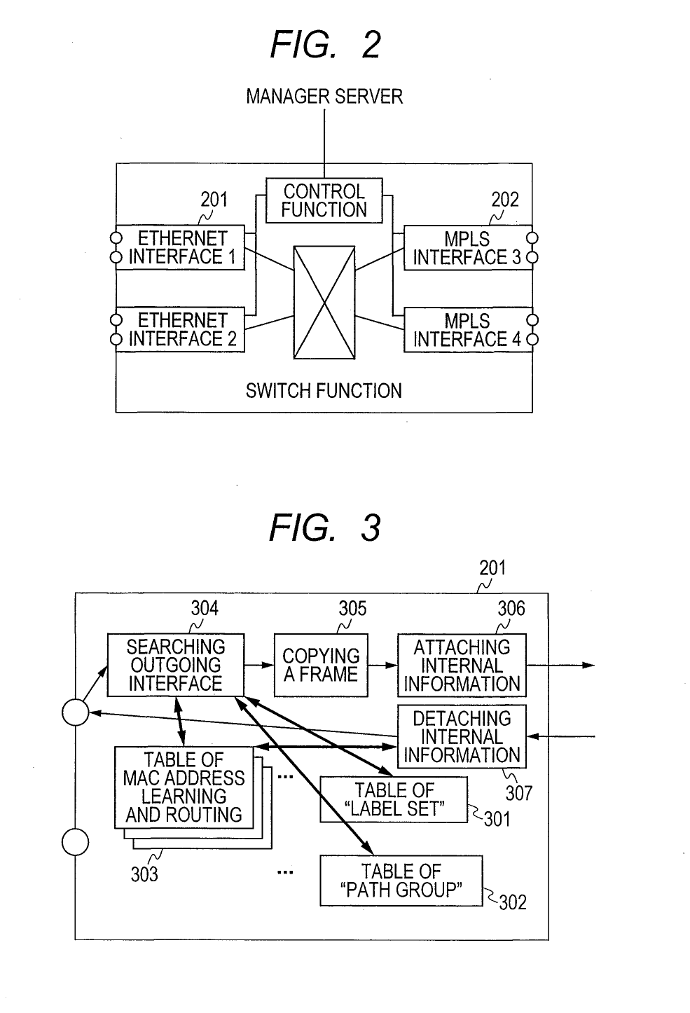

FIG. 2 is a diagram showing the configuration of each edge node 101.

Each edge node 101 includes at least one Ethernet interface card 201 connected to an external network, at least one MPLS interface card 202 connected to the P2P network system 108, a switch that connects between the interface cards, and a control function unit that controls these components. The control function unit is connected to the manager server 109 for the P2P network system 108.

FIG. 3 is a diagram showing the configuration of the Ethernet interface card 201.

The Ethernet interface card 201 contains, for example, a table of “Label Set” 301, a table of “Path Group” 302, and a table of MAC address learning and routing 303. The table of MAC address learning and routing 303 may be one that is typically used in Ethernet communication devices. The Ethernet interface card 201 includes, for example, an outgoing interface search function unit 304, as well as a frame copy function unit 305, an internal information attaching function unit 306, and an internal information detaching function unit 307. The frame copy function unit 305, the internal information attaching function unit 306, and the internal information detaching function unit 307 may be ones that are typically used in Ethernet communication devices.

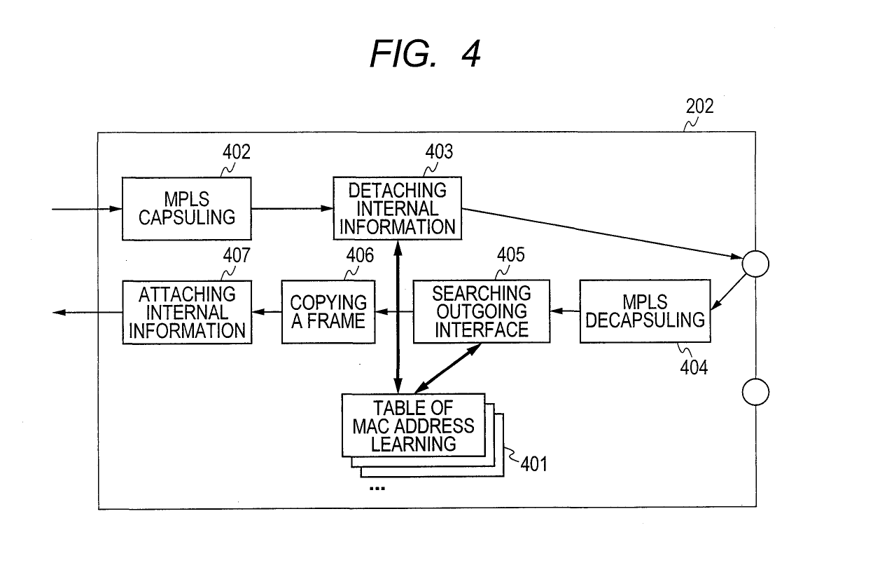

FIG. 4 is a diagram showing the configuration of the MPLS interface card 202.

For example, the MPLS interface card 202 contains a table of MAC address learning 401 and includes an MPLS capsulating function unit 402, an internal information detaching function unit 403, an MPLS decapsulating function unit 404, an outgoing interface search function unit 405, a frame copy function unit 406, and an internal information attaching function unit 407. The blocks of the MPLS interface card 202 are all general functions.

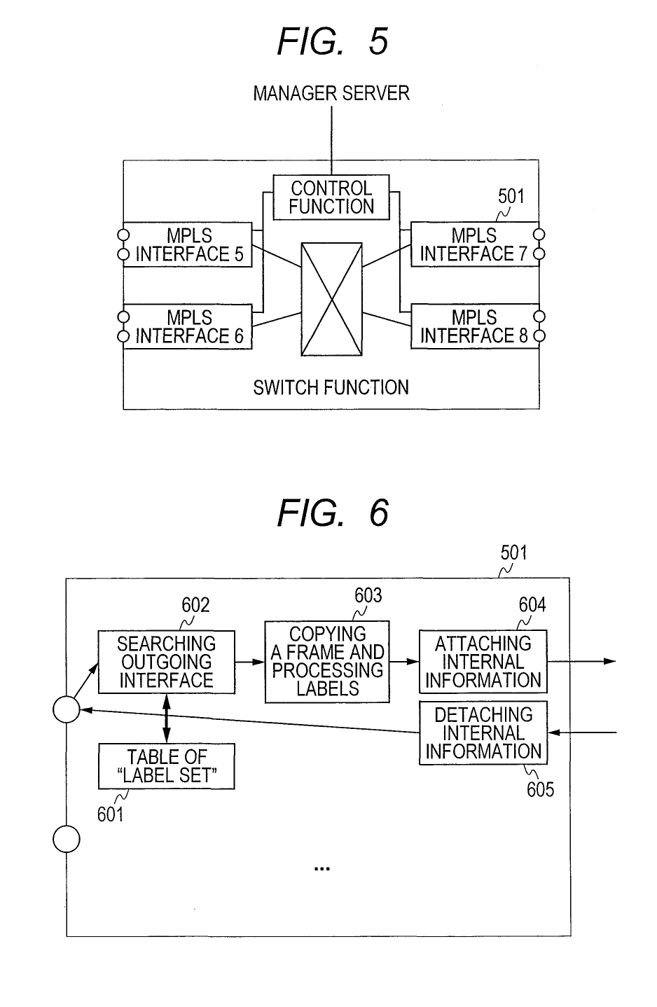

FIG. 5 is a diagram showing the configuration of each relay node 102. While each relay node 102 has a configuration similar to that of each edge node 101, it includes multiple MPLS interface cards 501 connected to the P2P network system 108 but includes no Ethernet interface cards 201.

FIG. 6 is a diagram showing the configuration of each MPLS interface card 501.

For example, each MPLS interface card 501 contains a table of “Label Set” 601 and includes an outgoing interface search function unit 602, a frame copy/label processing function unit 603, an internal information attaching function unit 604, and an internal information detaching function unit 605.

The above-mentioned function units will be described in detail later in the data frame processing section. The tables are stored in a memory. Data in the tables may be stored in the data storage area of the memory in an appropriate form rather than in the table form.

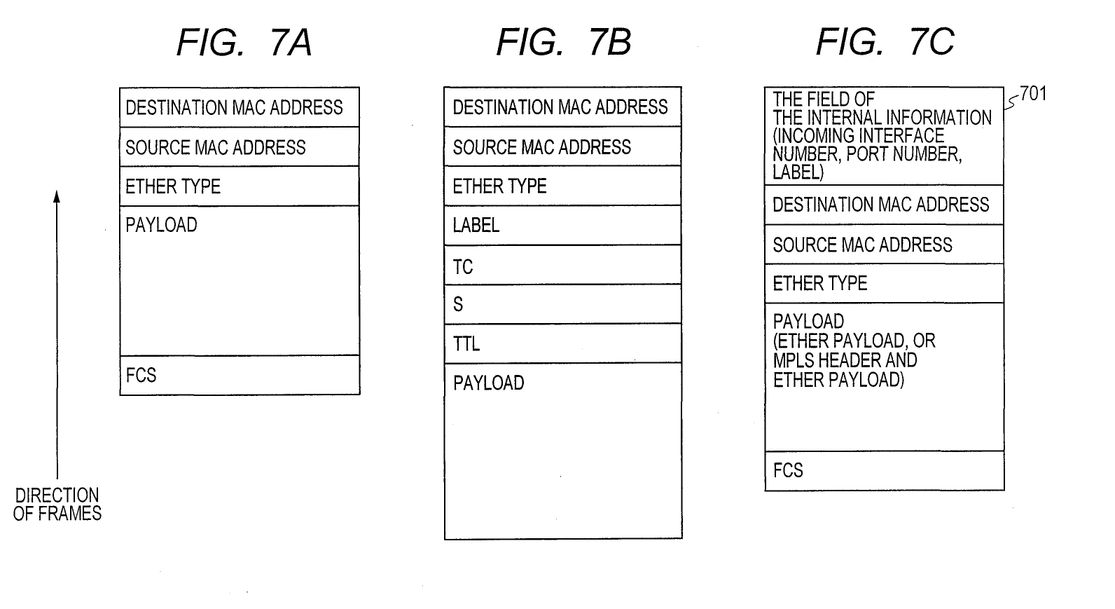

FIG. 7A shows the format of a data frame that is transmitted or received to or from an external network. FIG. 7B shows the format of a data frame that is transmitted or received within the P2P network system 108. FIG. 7C shows the format of a data frame within each edge node 101 or relay node 102. Although will not be described in detail, information processed by the function units of each node is stored in a field of internal information 701 shown in FIG. 7C and is passed between the function units.

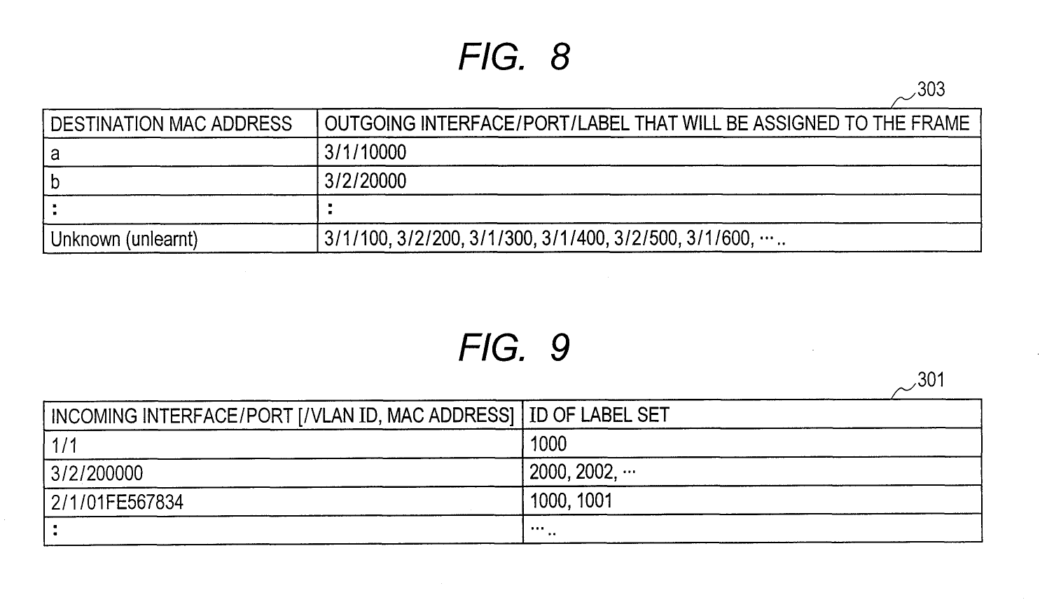

FIG. 8 shows an example configuration of the table of MAC address learning and routing 303 in each edge node 101.

That is, the table of MAC address learning and routing 303 is a table where each MAC address is used as the key and where the corresponding outgoing interface number, port number, and label are used as the value.

FIG. 9 shows an example configuration of the table of “Label Set” 301 in each edge node. That is, the table of “Label Set” 301 a table where the number of an interface into which a frame has been inputted, port number, VLAN ID and an MAC address are used as the key and where the identifier of the corresponding label set is used as the value. The VLAN ID and the MAC address may be omitted. For example, multiple VLANs may be formed in the network 108, and paths may be managed for each VLAN.

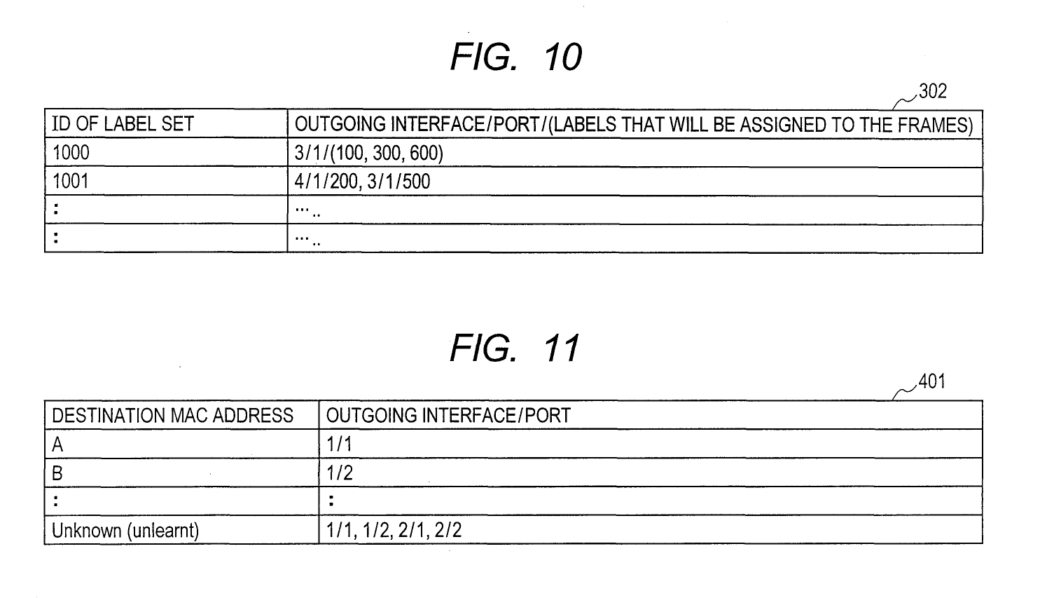

FIG. 10 shows an example of the table of “Path Group” 302 in each edge node. That is, the table of “Path Group” 302 is a table where the identifier of each label set is used as the key and where labels corresponding to each set of an outgoing interface number and an exit port number are used as the value. While, in this embodiment, the table of “Label Set” 301 and the table of “Path Group” 302 are prepared as separate tables via the identifiers of the label sets, these tables may be prepared as one table.

FIG. 11 shows an example of the table of MAC address learning 401 in each edge node. That is, the table of MAC address learning 401 is a table where each MAC address is used as the key and where the corresponding outgoing interface number and port number are used as the value.

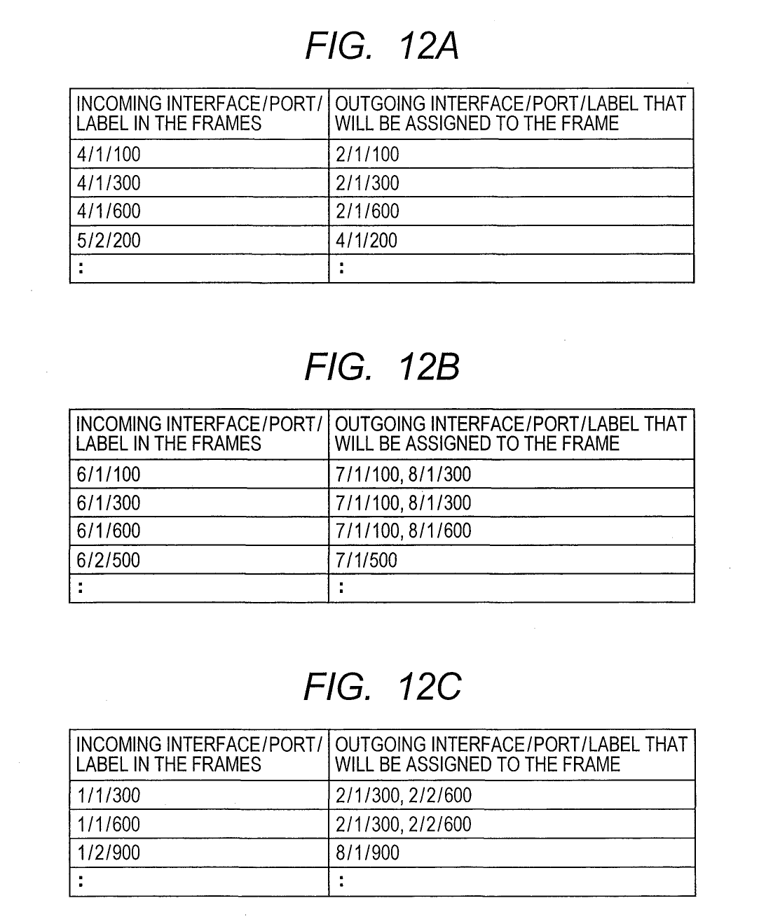

FIGS. 12A, FIG. 12B, and FIG. 12C show examples of the tables of “Label Set” 601 of the relay node C, the relay node E, and the relay node H, respectively. That is, the table of “Label Set” 601 is a table where each set of the number of an interface into which a frame has been inputted, port number, and label are used as the key and where the corresponding outgoing interface number, port number, and label are used as the value.

Next, the methods for preparing the tables shown in FIGS. 8 to 12 will be described.

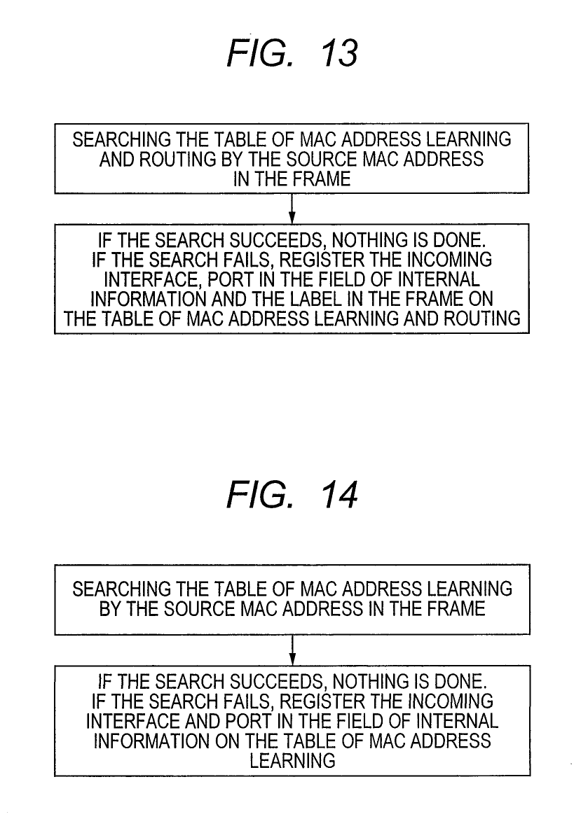

FIG. 13 shows the preparation flow of the table of MAC address learning and routing 303 for each edge node.

For example, the internal information detaching function 307 performs the following process with respect to a frame to be transferred from the P2P network system 108 to an external network 103. Using the source MAC address in the frame as the search key, the internal information detaching function 307 searches the table of MAC address learning and routing 303. If the search succeeds, it does nothing. If the search fails, the internal information detaching function 307 registers the incoming interface number, port number, and label in the field of internal information 701 of the frame, in the table of MAC address learning and routing 303 as the value. In this case, the key is the source MAC address in the frame.

FIG. 14 shows the preparation flow of the table of MAC address learning 401 for each edge node. While the flow is similar to that in FIG. 13, the value to be registered is the incoming interface number and the port number, and the label is not required. For example, the internal information detaching function unit 403 performs this process with respect to a frame to be transferred from an external network 103 to the P2P network system 108.

The table of “Label Set” 301 and the table of “Path Group” 302 for each edge node and the table of “Label Set” 601 for each relay node are previously prepared, for example, by manpower such as the network administrator or using some tool and then set at each edge node 101 and relay node 102 from the manager server 109 for the P2P network. In preparing the table of “Label Set” 601 for each relay node 102, the following points need to be noted. That is, if multiple labels belong to a pair of an outgoing interface number and a port number, only one of the labels is arbitrarily selected.

In addition to normal data paths, paths for flooding are set with respect to the data paths one-to-one. In other words, data frames for flooding and other data frames are transmitted separately. The labels shown in FIG. 10 are the labels of the paths for flooding. FIGS. 12A, 12B, and 12C can be used by both paths and paths for flooding. Note that if the label of the key is the label of a data path, the label of the value must also be the label of the data path and that if the label of the key is the label of a flooding path, the label of the value must also be the label of the flooding path. Since a data path is a point-to-point path, one triad of an outgoing interface number, a port number, and a label always corresponds to one key.

Next, as an example, the frame processing that the edge node D and the relay nodes C, E, and H perform in turn along the path represented by D-C-E-H-G shown in FIG. 1 will be described. For easy understanding, the following connection example will be described. That is, assume that the interface number 3 and the port number 1 of the edge node D are connected to the interface number 4 and the port number 1 of the relay node C. Also assume that the interface number 2 and the port number 1 of the node C are connected to the interface number 6 and the port number 1 of the relay node E and that the interface number 8 and the port number 1 of the node E are connected to the interface number 1 and the port number 1 of the relay node H.

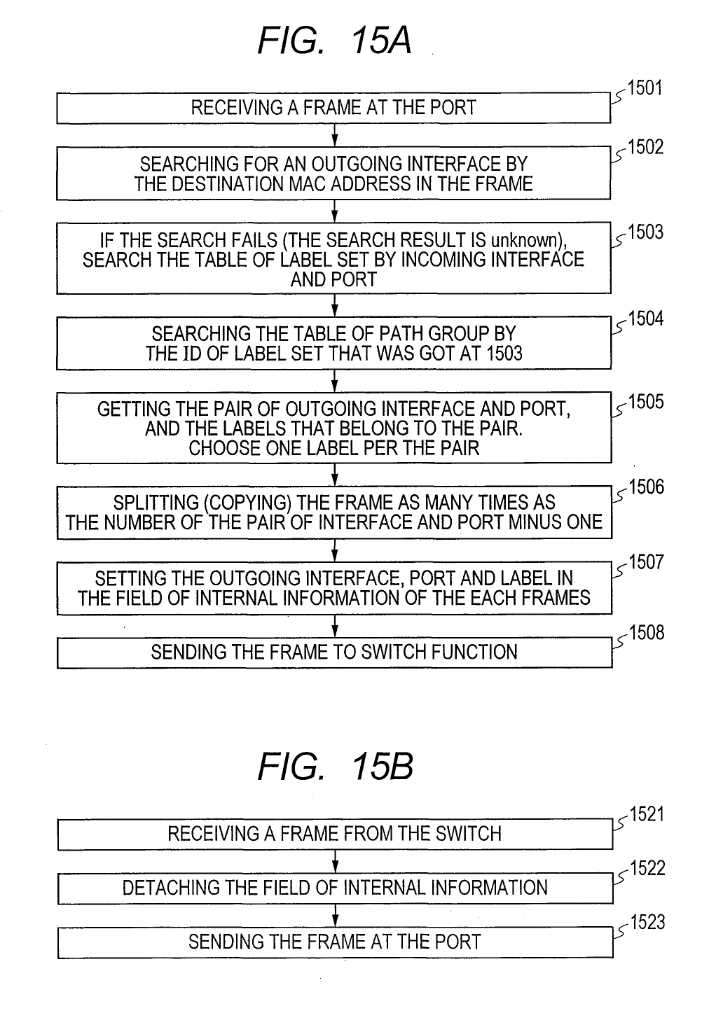

FIG. 15A shows the process flow in the case where the edge node 101 (D) receives an Ethernet frame.

The Ethernet interface card 201 receives an Ethernet frame from the external network 103 via a physical port thereof (1501), and the outgoing interface search function unit 304 searches the table of MAC address learning and routing 303 for the destination MAC address in the frame (1502). Here, assume that the destination MAC address is found to be unknown. The outgoing interface search function unit 304 then searches the table of “Label Set” 301 for the incoming interface number and the port number in the frame (1503). Here, assume that the interface number is 1 and that the port number is 1. Accordingly, an ID of Label Set 1000 is obtained by using the example shown in FIG. 9. The outgoing interface search function unit 304 further searches the table of “Path Group” 302 using the ID of Label Set 1000 obtained (1504). As a result, the outgoing interface search function 304 obtains at least one pair of an outgoing interface number and a port number, as well as at least one label corresponding to each pair. In the example shown in FIG. 10, the outgoing interface search function 304 obtains a pair 3/1 and 100,300,600 corresponding to the pair 3/1. The outgoing interface search function unit 304 selects any one from the labels obtained for each pair (1505). Here, assume that 100 is selected. The label may be selected using any appropriate method. Next, the frame copy function 305 copies the frame by the number of the pairs obtained in step 1505 minus one (1506). Since the number of pairs is one, the frame is not copied. The internal information attaching function 306 sets the interface number, the port number, and the label obtained in step 1505 at each of the frames, including the copied ones. In this example, 3, 1, 100 are set at the single frame. All such information is set in the field of internal information 701 of each frame (1507). The internal information attaching function 306 then transmits the frames to the switch (1508). The switch transfers the frames to the corresponding MPLS interface cards 202 in accordance with the interface number.

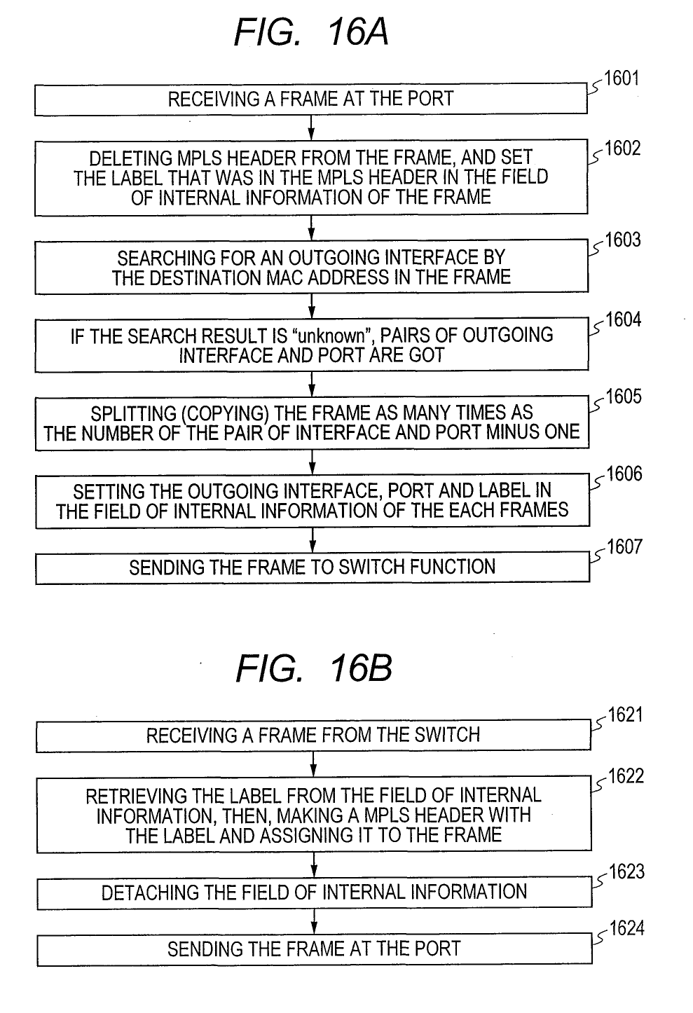

FIG. 16A shows the process flow in the case where the edge node D transmits an MPLS frame into the P2P network system 108.

One of the MPLS interface cards 202 receives a frame from the switch (1621). The MPLS capsulating function unit 402 retrieves the label from the field of internal information 701 of the frame, makes an MPLS header with the label, and assigns the MPLS header to the frame. Thus, the frame is formed into an MPLS frame shown in FIG. 7B. In this example, the MPLS interface card 202 having the interface number 3 receives a frame containing the label 100 from the switch at the port number 1 thereof and performs the above-mentioned step. TC (traffic class), TTL (time-to-live), or the like may be added to the frame as appropriate. The internal information detaching function unit 403 then detaches the field of internal information from the frame (1623). The edge node D then transmits the MPLS frame from the corresponding physical port (1624).

FIG. 16B shows the process flow in the case where the edge node D receives an MPLS frame from the P2P network system 108.

One of the MPLS interface cards 202 receives an MPLS frame at a port thereof (1601), deletes the MPLS header from the frame using the MPLS decapsulating function unit 404, and stores the label in the MPLS header, in the field of internal information 701 of the frame (1602). The outgoing interface search function unit 405 then searches the table of MAC address learning 401 for the destination MAC address in the frame (1603). If the destination MAC address is found to be unknown, the outgoing interface search function unit 405 obtains multiple sets of an outgoing interface number and a port number (1604). The frame copy function 406 copies the frame by the number of the sets obtained in 1604 minus one (1605). The internal information attaching function 407 sets the interface number, the port number, and the label at each of the frames, including the copied ones. All such information is set in the field of internal information of each frame (1606). Lastly, the information addition function unit 407 transmits the frames to the switch (1607).

FIG. 15B shows the process flow in the case where the edge node D transmits an Ethernet frame to the corresponding external network 103. The edge node D receives a frame from the switch (1521) and deletes the field of internal information from the frame using the internal information detaching function 307 (1522). The edge node D then transmits the Ethernet frame from a physical port thereof (1523).

Next, the frame processing that each relay node 102 performs will be described. First, the process flow, which is common to the relay nodes C, E, and H, will be described. Then, the process that each node Performs will be described using specific parameters as examples.

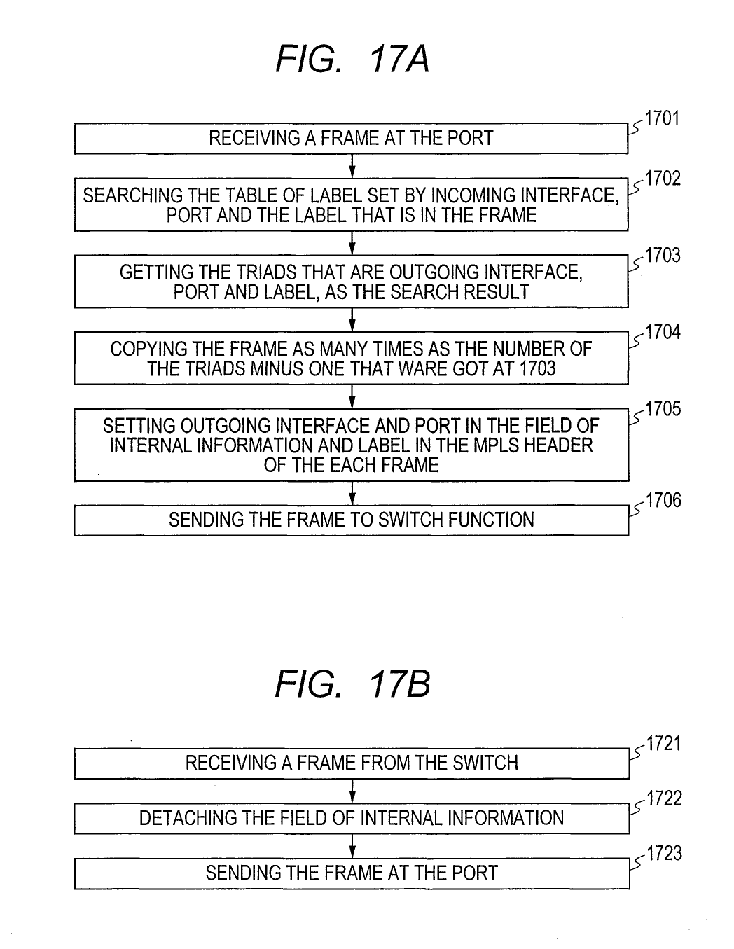

FIG. 17A shows the process flow in the case where a relay node receives an MPLS frame from the P2P network system 108. One of the MPLS interface cards 501 receives an MPLS frame at a port thereof (1701). The outgoing interface search function unit 602 searches the table of “Label Set” shown in FIG. 12A, 12B, or 12C using the incoming interface number, the port number, and the label in the frame as the key (1702). As a result, the outgoing interface search function unit 602 obtains a triad of an outgoing interface number, a port number, and a label (1703). Multiple triads may be obtained. In such a case, the frame copy/label processing function unit 603 copies the frame by the number of the triads obtained minus one (1704). The internal information attaching function 604 then sets the outgoing interface number, the port number, and the label at each of the frames, including the copied ones. The outgoing interface number and the port number are set in the field of internal information 701 of each frame, and the label is set in the MPLS header (1705). The internal information attaching function unit 604 then transmits the frames, including the copied ones, to the switch (1706).

FIG. 17B shows the process flow in the case where a relay node transmits an MPLS frame into the P2P network system 108. One of the MPLS interface cards 501 receives an MPLS frame from the switch (1721) and detaches the field of internal information 701 from the frame using the internal information detaching function unit 605 (1722). The MPLS interface card 501 then transmits the MPLS frame from a physical port thereof (1723).

Assume that the relay node C receives a frame having the label 100 at the interface number 4 and the port number 1. In step 1702, the relay node C obtains the outgoing interface number 2, the port number 1, and the label 100 from FIG. 12A. Since the number of the triads obtained is one, the relay node makes no copy of the frame, and adds these pieces of information to the frame and transmits the frame to the switch. At the relay node C, three paths are set at one port. These paths are regarded as one group, which is then assigned one label.

Assume that the relay node E receives a frame having the label 100 at the interface number 6 and the port number 1. In step 1702, the relay node E obtains, from FIG. 12B, the outgoing interface number 7, the port number 1, and the label 100, as well as the outgoing interface number 8, the port number 1, and the label 300. Since the number of the triads obtained is two, the relay node E makes one copy of the frame (step 1704). The relay node E adds the outgoing interface number 7, the port number 1, and the label 100 to the original frame, as well as adds the outgoing interface number 8, the port number 1, and the label 300 to the copied frame, and then transmits the two frames to the switch. At the relay node E, two paths are set at the interface number 8 and the port number 1. These paths are regarded into one group, which is then assigned one label. The path set at the interface number 7 and the port number 1 is connected, for example, to the edge node A in FIG. 1 and belongs to a group different from the above-mentioned group.

Assume that the relay node H receives a frame having the label of 300 at the interface number 1 and the port number 1. In step 1702, the relay node H obtains, from FIG. 12C, the outgoing interface number 2, the port number 1, and the label 300, as well as the outgoing interface number 2, the port number 2, and the label 600. Since the number of the triads obtained is two, the relay node H makes one copy of the frame (step 1704). For example, the relay node H adds the outgoing interface number 2, the port number 1, and the label 300 to the original frame, as well as adds the outgoing interface number 2, the port number 2, and the label 600 to the copied one, and then transmits the two frames to the switch. For example, the edge node H transfers one of the frames to the edge node G and transfers the other to the edge node I.

The present invention is applicable to data communication systems and data communication devices conforming to the Ethernet and MPLS standards. The present invention is also applicable to devices that transmit or receive data via a point-to-point connection.

What is claimed is:

1. A network system comprising:
a plurality of edge devices that form point-to-point communication paths with one another and transmit or receive frames to or from one another via the point-to-point communication paths; and
a relay device that relays frames between the edge devices,
wherein the edge devices and/or the relay device each include:
a plurality of ports that receive and output frames;
a memory where plurality of communication paths that are set at one of the ports are regarded as a group and where identification information of the port and identification information of the group that outputs a frame which was inputted into the port are previously stored as associated with each other; and
an outgoing interface search unit that, if the destination address of a frame inputted into one of the ports is unknown, searches the memory to identify at least one group corresponding to the port, and the frame containing the unknown destination address is outputted from a port corresponding to the identified group.

2. The network system according to claim 1,
wherein one frame is transmitted to the one port at which the communication paths are set.

3. The network system according to claim 1,
wherein in the memory of each of the edge devices, a label to be assigned to a frame inputted into the port is further stored as associated with the identification information of the port, and
wherein when a frame is inputted into the port, the label is added to the frame, and the frame is outputted.

4. The network system according to claim 3,
wherein in the memory of the relay device, the identification information of the port and a label in a frame to be inputted, and the identification information of the group and a label to be assigned to a frame to be outputted are stored as associated with each other, and
wherein when a frame is inputted into the port, the outgoing interface search unit refers to the memory on the basis of the identification information of the port and a label in the frame so as to identify identification information of a corresponding group and a label to be assigned to the frame, adds the identified label to the frame, and outputs the frame from a port corresponding to the identified group.

5. The network system according to claim 1,
wherein a plurality of communication paths belonging to an identical LAN connection are regarded as one set,
wherein the group is generated by classifying the communication paths forming the one set by port,
wherein in the memory of each of the edge devices, the identification information of the port and a VLAN identifier or MAC address in a frame, the VLAN identifier being intended to identify a LAN connection to which the frame belongs, and identification information of the group belonging to the LAN connection are stored as associated with each other, and
wherein when a frame is inputted into the port, the outgoing interface search unit refers to the memory on the basis of the identification information of the port and a VLAN identifier or MAC address in the frame so as to identify at least one corresponding group.

6. The network system according to claim 1,
wherein the memory of each of the edge devices and/or the relay device contains an address learning table where the address of a frame transmitted or received via the port and port information are stored as associated with each other, and
wherein if the destination address of a received frame is stored in the address learning table, the frame is outputted in accordance with corresponding port information, and if the destination address of a received frame is not stored in the address learning table, the group is identified.

7. A plurality of edge devices that are included in a network system along with a relay device, form a plurality of point-to-point communication paths with one another, and transmit or receive frames to or from one another via the point-to-point communication paths, the relay device relaying frames between the edge devices, each edge device comprising:
a plurality of ports that receive and output frames;
a memory where communication paths that are set at one of the ports are regarded as a group and where identification information of the port and identification information of the group that outputs a frame which was inputted into the port are previously stored as associated with each other; and
an outgoing interface search unit that, if the destination address of a frame inputted into one of the ports is unknown, searches the memory to identify at least one group corresponding to the port,
wherein the frame containing the unknown destination address is outputted from a port corresponding to the identified group.

8. A relay device that is included in a network system along with a plurality of edge devices and relays frames between the edge devices, the edge devices forming point-to-point communication paths with one another and transmitting or receiving frames to or from one another via the point-to-point communication paths, the relay device comprising:
a plurality of ports that receive and output frames;
a memory where communication paths that are set at one of the ports are regarded as a group and where identification information of the port and identification information of the group that outputs a frame which was inputted into the port are previously stored as associated with each other; and
an outgoing interface search unit that, if the destination address of a frame inputted into one of the ports is unknown, searches the memory to identify at least one group corresponding to the port,
wherein the frame containing the unknown destination address is outputted from a port corresponding to the identified group.
